(19) United States
(12) Patent Application Publication
(10) Pub. No.: US 2025/0110541 A1
(43) Pub. Date: Apr. 3, 2025

(54) METHODS AND APPARATUS TO REDUCE MEMORY POWER CONSUMPTION

(71) Applicant: Intel Corporation, Santa Clara, CA (US)

(72) Inventors: Angad Hiteshbhai Shah, Bangalore (IN); Harithaa Varshini V, Bangalore (IN); Uma Maheswari Trichy Sundaram, Chennai (IN); Subhojit Saha, Bengaluru (IN); Ashwin Sesha Srinivasan, Coimbatore (IN); Sriram S, Kumbakonam (IN); Ravi Sri Himaja, Bangalore (IN)

(73) Assignee: Intel Corporation, Santa Clara, CA (US)

(21) Appl. No.: 18/979,229

(22) Filed: Dec. 12, 2024

(51) Int. Cl. G06F 1/324; G06F 1/3234

(52) U.S. Cl. CPC G06F 1/324; G06F 1/3275

(57) ABSTRACT

An example apparatus includes memory; machine-readable instructions; and at least one programmable circuit to at least one of execute or instantiate the machine-readable instructions to at least adjust a frequency of a clock signal of the memory based on workload demands of a processor circuit.

### BACKGROUND

Computing devices include one or more processor circuits (e.g., central processing units (CPUs), graphical processing units (GPU), etc.) and one or more memories. Computing devices are powered by a power source (e.g., a battery, an external power source, etc.). The components of computing devices operate based on one or more clock signals. For example, the processor circuit(s) and/or memory(ies) may synchronize operations based on the one or more clock signals. For example, a memory can synchronize actions and execute reads and writes using a clock signal.

### BRIEF DESCRIPTION OF THE DRAWINGS

FIG. 1 is an example computing device.

FIGS. 2A-2C illustrate a flowchart representative of example machine-readable instructions and/or operations that may be executed, instantiated, and/or performed by programmable circuitry to implement the computing device of FIG. 1.

FIG. 3 is a diagram illustrating package power consumption versus memory speed.

FIG. 4 is a block diagram of an example processor platform including programmable circuitry structured to execute, instantiate, and/or perform the computer readable instructions and/or perform the example operations of FIGS. 2A-2C to implement the computing device of FIG. 1.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIGS. 2A-2C) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example.

### In general, the same reference numbers will be used throughout the drawing(s) and accompanying written description to refer to the same or like parts. The figures are not necessarily to scale.

### DETAILED DESCRIPTION

Memory in a computing device utilizes power and a clock signal to operate. A power source (e.g., a battery, an external power source, etc.) provides the power for the memory to operate and the memory utilizes a clock signal to synchronize actions and execute reads and writes. An oscillator generates a clock signal and a phase-locked loop (PLL) adjusts the clock signal to one or more frequencies necessary for proper operation of the memory. A high supply voltage improves stability and headroom of the memory. The higher the clock frequency used by the memory the higher the supply voltage should be to maintain a minimum amount of stability and headroom. A higher frequency of the memory clock signal allows for more operations to occur within a duration of time than a lower frequency, thereby increasing performance. Accordingly, higher supply voltage and higher clock frequency improve performance of the computing device.

Although operating a higher supply voltage and higher clock frequency improves performance, the higher the supply voltage and the higher the clock frequency, the more power that the memory consumes. Increasing power consumption is less energy efficient. A memory operating at a higher frequency and/or with a higher supply voltage draws power from the power source faster than memory operating with less power consumption. Some conventional techniques dynamically adjust the frequency of the clock used by memory based on display bandwidth requirements. For example, if display bandwidth requirements are high (e.g., because the computing device is streaming high-definition video, playing a video game, performing media editing, etc.), conventional techniques increase the frequency of the clock applied to the memory to increase performance. If display bandwidth requirements are lower, conventional techniques decrease the frequency of the clock applied to the memory to conserve power. The display bandwidth is the rate at which data can be transferred to a display (e.g., a monitor, a screen, etc.). The display bandwidth corresponds to how much information can be displayed on a screen per unit of time (e.g., a second).

However, such conventional techniques fail to address high idle power consumption. In idle situations and/or low-load situations, the supply voltage and clock frequency can be reduced without sacrificing performance, even if the displace bandwidth requirements are high. Even if the display bandwidth is moderate, such conventional techniques provide poor power efficiency as the supply voltage and/or frequency can be reduced. Accordingly, conventional techniques exhibit excessive power consumption, increased heat generation, and reduced battery life in computing devices.

Examples disclosed herein reduce power consumption by dynamically adjusting the memory frequency and supply voltage provided to the memory based on the actual workload, playback demands, and/or the display bandwidth, rather than adjusting the memory frequency and supply voltage provided to the memory solely based on display bandwidth. Examples disclosed herein reduce memory clock frequency and/or supply voltage lower (e.g., minimum supported signal supported by the PLL) during idle periods and scales up the frequency and/or supply voltage based on workload demands. Examples disclosed herein result in power savings during idle, playback, and low-load scenarios.

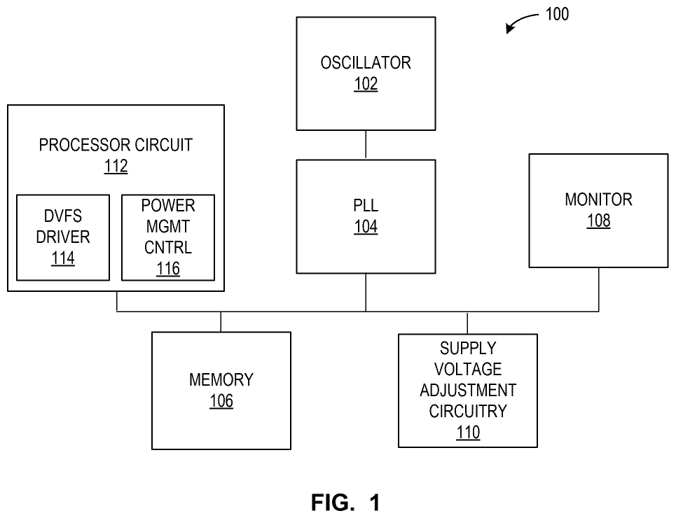

FIG. 1 illustrates an example computing device 100 (e.g., a computer, a tablet, a laptop, a smart phone, etc.). The computing device 100 includes an example oscillator 102, an example phase-locked loop (PLL) 104, example memory 106, an example monitor 108, example supply voltage adjustment circuitry 110, an example processor circuit 112, an example dynamic voltage and frequency scaling (DVFS) driver 114, and an example power management controller (PMC) 116.

The example oscillator 102 of FIG. 1 generate a clock signal (e.g., a periodic electric signal), such as a clock wave, a sine wave, etc. The oscillator 102 outputs the generated clock signal to the PLL 104.

The PLL 104 of FIG. 1 converts the clock signal from the oscillator 102 to one or more clock signals with different frequencies. Because each component of the computing device 100 may rely on a clock signal at one or more predefined frequencies, the PLL 104 can generate the one or more clock signals at the one or more predefined frequencies and distribute appropriate clock signals to the corresponding components of the computing device 100. As further described below, the DVFS driver 114 can instruct the PLL 104 to adjust the frequency of the clock signal output to the memory 106 based on the workload, playback demands, and/or the display bandwidth. In some examples, the PLL 104 may be replaced with a delayed locked loop.

The memory 106 of FIG. 1 reads and/or writes data into memory cells based on instructions from the processor circuit 112. For example, the processor circuit 112 (e.g., a memory controller) transmits signals to the memory 106 to access video data to be displayed on the monitor 108. The memory 106 operates based on the clock signal (e.g., where read operations, write operations, etc. are synchronized based on the pulses of the clock signal). The memory 106 is structured to operate based on a range of frequencies of the clock signal (e.g., corresponding to between 4 Giga-transfers per second (GT) and 16 GT). Within such a range, the lower the frequency, the slower the performance but the more energy (e.g., power) is conserved. The higher the frequency, the faster the performance but at the cost of high resource consumption. Also, the memory 106 is structured to operate within a range of voltage for the power supply (e.g., 1.2 V to 1.5 V). For lower clock signal frequencies, where operations occur less often, the power supply can be lowered to conserve power. However, at higher clock signal frequencies, a higher supply voltage is needed for proper operation.

The monitor 108 of FIG. 1 may be any type of screen or monitor. The monitor 108 displays images/video. The monitor 108 obtains the data needed to display the images/video from the memory 106 based on control signal(s) from the processor circuit 112. The monitor 108 exhibits a display bandwidth. The display bandwidth is the rate at which data flows to the monitor 108 (e.g., from the memory 106). The display bandwidth demand increases with an increase in resolution of a displayed image, increased refresh rate, and/or increased color depth. As further described below, the DVFS driver 114 monitors the display bandwidth to determine an appropriate clock frequency and/or supply voltage to apply/provide to the memory 106 which balances performance and power consumption.

The supply voltage adjustment circuitry 110 of FIG. 1 adjusts the supply voltage applied to the memory 106 based on a control signal from the DVFS driver 114. For example, the supply voltage adjustment circuitry 110 can change the supply voltage of the memory 106 from between 1.2 to 1.5 V using voltage conversion circuitry.

The processor circuit 112 of FIG. 1 may be a central processing unit (CPU), a graphical processing unit (GPU), a digital signal processor (DSP), a microcontroller, and/or any other type of processor circuit. The processor circuit 112 causes rendering and displaying of images, videos, etc. on the monitor 108 by interacting the memory 106. For example, the processor circuit 112 can work with the memory 106 to transfer one or more images (e.g., video) to the monitor 108 for display.

The processor circuit 112 includes the DVFS driver 114. In some examples, the DVFS driver 114 may be implemented by DVFS circuitry for analog-base designs. The DVFS driver 114 monitors workload demands, display bandwidth, and user interaction (e.g., how the user is using the computing device 100 (and, thus, the processor circuit 112)). The workload demands correspond to applications that use the processor circuit 112 handles. For example, a streaming application is a type of workload that streams video (e.g., high resolution video) via the monitor 108. The display bandwidth corresponds to the rate at which data flows from the memory 106 to the monitor 108. User interaction may correspond to settings that a user enabled. For example, a user can select whether to stream a video as a 420-resolution video or as a 4K video. Additionally, the user can select a higher or lower refresh rate, depth of colors, etc. and each such setting can affect the display bandwidth. Additionally, user interaction may include how and/or how much the user is interacting with the computing device 100. For example, if the user is playing a video game, user interaction may include whether the user actively providing inputs (e.g., moving mouse, typing, etc.), whether the user has paused program and/or if the user has opened a menu screen, etc. If the DVFS driver 114 determines that one or more workload(s) is creating a high workload demands (e.g., media editing, high resolution streaming, video game play, etc.), the display bandwidth is above a threshold, and/or the user interaction corresponds to higher display bandwidth, the DVFS driver 114 can request (e.g., to the PMC 116) an increase of the clock frequency and/or an increase of voltage from the power supply. If the DVFS driver 114 determines that one or more of the workload(s) is causing low workload demands (e.g., no application, word processing, low resolution media play, etc.), the display bandwidth is below a threshold, and/or the user interaction corresponds to lower display bandwidth, DVFS driver 114 can request (e.g., to the PMC 116) a decrease of the clock frequency and/or decrease the voltage from the power supply.

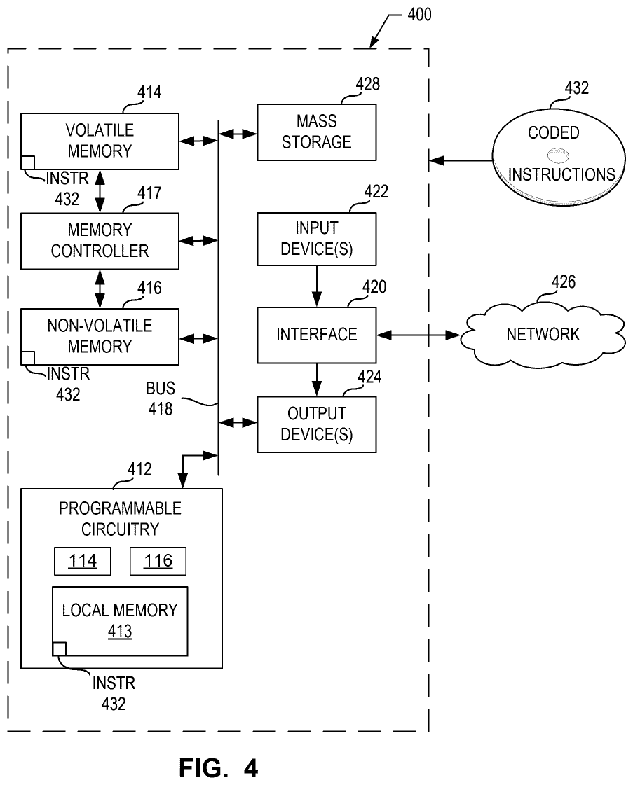

The PMC 116 of FIG. 1 outputs a control signals to the PLL 104 to adjust the clock frequency of the memory 106 based on a request from the DVFS driver 114. Additionally, the PMC 116 outputs a control signal to the supply voltage adjustment circuitry 110 to adjust the supply voltage provided to the memory 106 based on a request from the DVFS driver 114. In some examples, the PMC 116 can monitor one or more of the display bandwidth or the workload demands instead of and/or in addition to the DVFS driver 114 to trigger a change in clock frequency and/or supply voltage provided to the memory 106. The PMC 116 transmits control signals to the PLL 104 and/or the supply voltage adjustment circuitry 110 based on the workload demands, the display bandwidth, and/or user interface (e.g., based on a request from the DVFS driver 114 and/or local monitoring). In response to a request to adjust the clock frequency, the PMC 116 requests a memory controller (e.g., the processor 112 and/or the memory controller 417 of FIG. 4) to perform memory training to ensure that operation of the memory 106 is successful at the adjusted clock frequency. Operation of the memory 106 is successful based on a successful indication from memory training, which indicates that the memory 106 is operating properly based on the selected clock frequency. Memory training includes running diagnostics based on memory configurations in an attempt to find and/or correct defects. The memory training protocol results in a success if the diagnostic test(s) pass or a failure if the diagnostic test(s) fail. If the memory training results in success, the PMC 116 adjusts the clock frequency for the memory 106 by transmitting a control signal to the PLL 104. If the memory training results in a failure, the PMC 116 maintains the previous clock frequency for the memory 106.

While an example manner of implementing computing device 100 is illustrated in FIG. 1, one or more of the elements, processes, and/or devices illustrated in FIG. 1 may be combined, divided, re-arranged, omitted, eliminated, and/or implemented in any other way. Further, the oscillator 102, the PLL 104, the memory 106, the monitor 108, the supply voltage adjustment circuitry 110, the processor circuit 112, the DVFS driver 114, the PMC 116, and/or, more generally, computing device 100 of FIG. 1, may be implemented by hardware alone or by hardware in combination with software and/or firmware. Thus, for example, any of the oscillator 102, the PLL 104, the memory 106, the monitor 108, the supply voltage adjustment circuitry 110, the processor circuit 112, the DVFS driver 114, the PMC 116, and/or, more generally, computing device 100 of FIG. 1, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the oscillator 102, the PLL 104, the memory 106, the monitor 108, the supply voltage adjustment circuitry 110, the processor circuit 112, the DVFS driver 114, the PMC 116, and/or, more generally, computing device 100 of FIG. 1 may include one or more elements, processes, and/or devices in addition to, or instead of, those illustrated in FIG. 1, and/or may include more than one of any or all of the illustrated elements, processes, and devices.

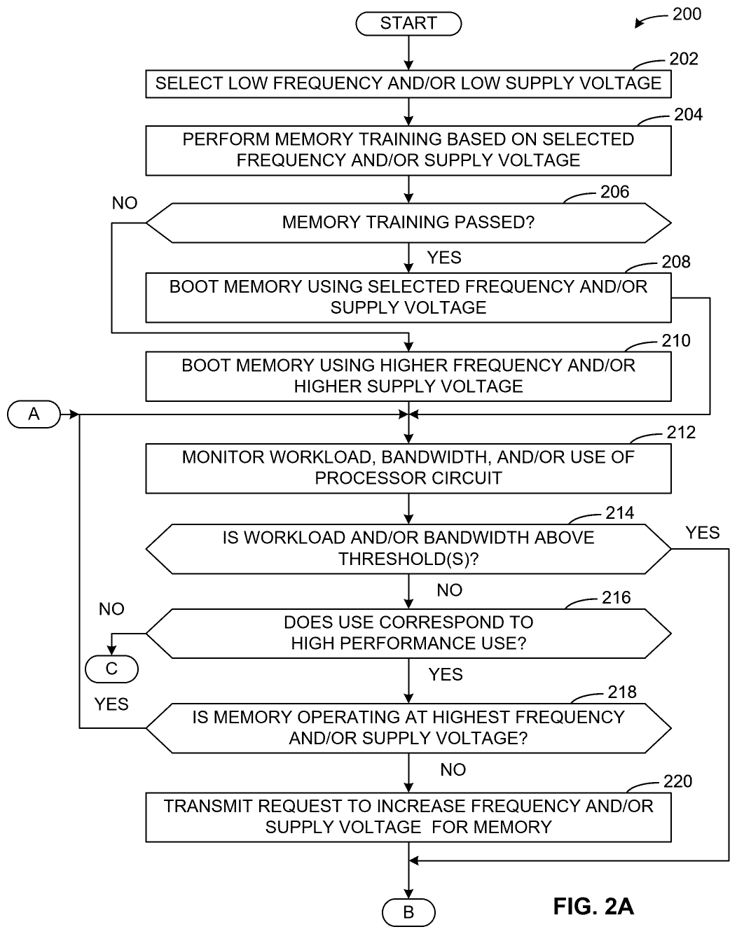

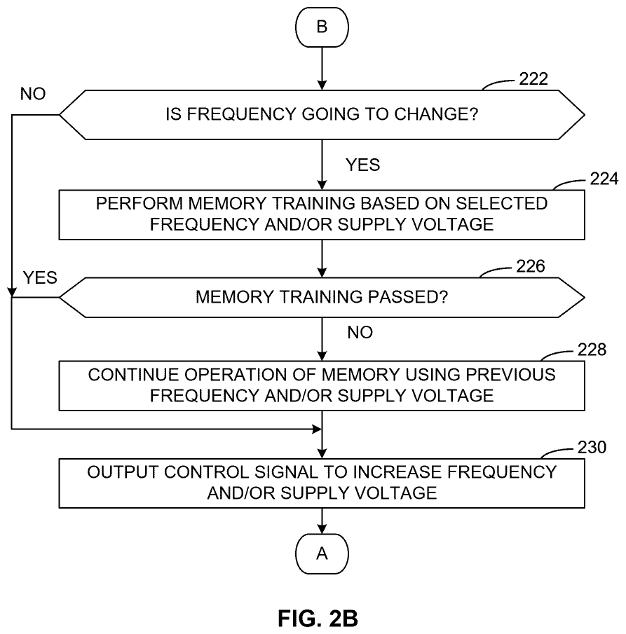

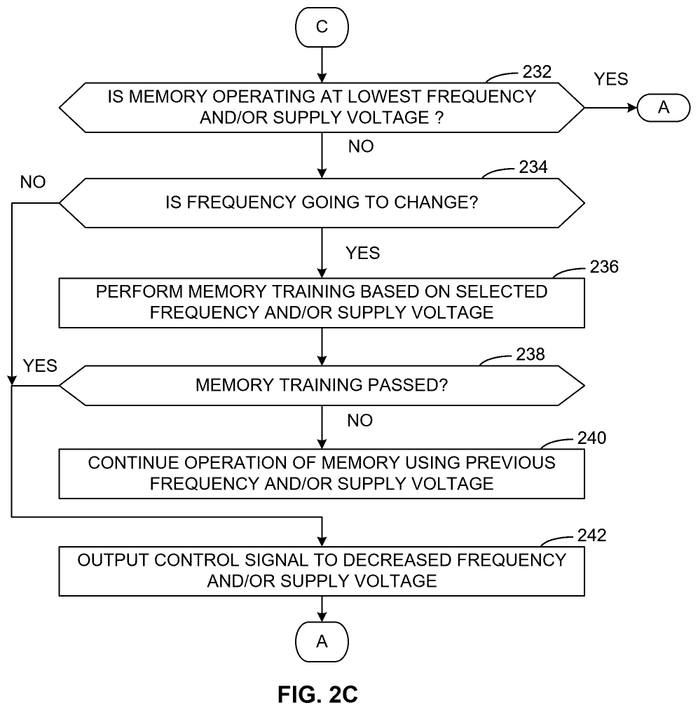

Flowchart(s) representative of example machine-readable instructions, which may be executed by programmable circuitry to implement and/or instantiate the computing device 100 of FIG. 1 and/or representative of example operations which may be performed by programmable circuitry to implement and/or instantiate the computing device 100 of FIG. 1, is shown in FIGS. 2A-2C. The machine-readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), synchronous random access memory (SRAM) dual in-line memory module (DIMM) memory, double data rate (DDR) memory, high bandwidth memory (HBM), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2A-2C, many other methods of implementing computing device 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, Go Lang, PyTorch, Rust, etc.

As mentioned above, the example operations of FIGS. 2A-2C may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, one or more data processing units (DPUs), one or more edge processing units (EPUs), one or more infrastructure processing units (IPUs), etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIGS. 2A-2C includes a flowchart representative of example machine-readable instructions and/or example operations 200 that may be executed, instantiated, and/or performed by programmable circuitry(ies) to reduce an action pace for workload execution. For example, the example operations 200 may be executed, instantiated, and/or performed by at least one of computing device 100. The example machine-readable instructions and/or the example operations 200 of FIG. 2 begin at block 202, at which the power management controller 118 selects a low frequency and/or low supply voltage. The low frequency and/or low supply voltage may be the lowest frequency and/or lowest supply voltage that the memory 106 supports for proper operation.

At block 204, the PMC 116 instructs a memory controller to perform memory training based on the selected frequency and/or supply voltage. Memory training may include process(es) to initialize the memory 106, configure firmware for the memory 106, perform tests, etc. Because, during bootup, there is minimal, if any, bandwidth/workload strain, the memory 106 can initiate with a lower clock frequency and/or lower voltage for the supply voltage so long as the memory training is successful. The memory controller provides the memory training results to the PMC 116 after complete.

At block 206, the PMC 116 determines if the memory training has passed (e.g., was successful). If the PMC 116 determines that the memory training has not passed (block 206: YES), the PMC 116 boots the memory 106 using a selected low frequency and/or low supply voltage (block 208). If the PMC 116 determines that the memory training has not passed (block 206: NO), the PMC 116 boots the memory 106 using a higher frequency and/or higher supply voltage (e.g., a clock frequency and/or supply voltage between the lowest frequency/voltage supported by the memory 106 and the highest frequency/voltage supported by the memory 106) (block 210).

At block 212, the DVFS driver 114 monitors the workload demands, display bandwidth, and/or use of the processor circuit 112. In some examples, the PMC 116 additionally or alternatively monitors one or more of the display bandwidth and/or the user of the processor circuit 112. As described above, the workload demands correspond to applications that use the processor circuit 112 to handle tasks. For example, a streaming application is a type of workload that streams video (e.g., high resolution video) via the monitor 108. The display bandwidth corresponds to the rate at which data flows from the memory 106 to the monitor 108. User interaction may correspond to settings that a user enabled. For example, a user can select whether to stream a video as a 420-resolution video or as a 4K video. Additionally, the user can select a higher or lower refresh rate, depth of colors, etc. that each can affect the display bandwidth. Additionally, user interaction may include how and/or how much the user is interacting with the computing device 100. For example, if the user is playing a video game, user interaction may include whether the user actively providing inputs (e.g., moving mouse, typing, etc.), whether the user in a pause or menu screen, etc.

At block 214, the DVFS driver 114 determines if the workload demands correspond to a high workload application and/or the display bandwidth is above a threshold. In some examples, workload demands may correspond to a high workload if the application always results in high display bandwidth. For example, workload demands may correspond to a video game, that may be a high workload for portions of time and a low workload (e.g., idle) for other portions of time (e.g., if paused, in a menu screen, etc.). Accordingly, such an application may correspond to a mixed workload demands application as opposed to a high workload application. Other applications (e.g., 4K streaming) may correspond to high workload applications because 4K video may require consistent high display bandwidth throughout.

If the DVFS driver 114 determines that the workload demands do not to a high workload application and/or the display bandwidth is not above a threshold (block 216: NO), control continues to block 232 of FIG. 2C. If the DVFS driver 114 determines that the workload demands correspond to a high workload application and/or the display bandwidth is above a threshold (block 216: YES), the DVFS driver 114 determines if the memory 106 is operating at the highest frequency and/or highest supply voltage that the memory 106 supports (block 218). If the DVFS driver 114 determines that the memory 106 is operating at the highest frequency and/or the highest supply voltage that the memory 106 supports (block 218: YES), control returns to block 212 because the clock frequency and/or supply voltage cannot be further increased. If the DVFS driver 114 determines that the memory 106 is not operating at the highest frequency and/or highest supply voltage that the memory 106 supports (block 218: NO), the DVFS driver 114 transmits a request to the PMC 116 to increase the clock frequency and/or supply voltage for the memory 106 (block 220).

At block 222, the PMC 116 determines if the clock frequency has been selected to change. The DVFS driver 114 can request adjustment of clock frequency and/or supply voltage based on user and/or manufacturer preferences. If the PMC 116 determines that clock frequency is not going to change (block 222: NO), control continues to block, 230. If the PMC 116 determines that clock frequency is going to change (block 222: YES), the PMC 116 performs frequency training based on the selected frequency and/or supply voltage (block 224). At block 226, the PMC 116 determines if the memory training has passed (e.g., was successful).

If the PMC 116 determines that the memory training has not passed (block 226: NO), the PMC 116 continues operation of the memory 106 using the previously selected frequency and/or supply voltage (block 228). If the PMC 116 determines that the memory training has passed (block 226: YES), the PMC 116 outputs one or more control signals to the PLL 104 and/or the supply voltage adjustment circuitry 110 to increase the clock frequency and/or increase the voltage for the supply voltage for the memory 106 (block 230).

At block 232 of FIG. 2C, the PMC 116 determines if the memory 106 is operating at the lowest frequency and/or lowest supply voltage supported by the memory 106. If the PMC 116 determines that the memory 106 is operating at the lowest frequency and/or lowest supply voltage supported by the memory 106 (block 234: YES), control returns to block 212 of FIG. 2A because the clock frequency and/or supply voltage cannot be further decreased. If the PMC 116 determines that the memory 106 is not operating at the lowest frequency and/or lowest supply voltage supported by the memory 106 (block 234: NO), the PMC 116 determines if the frequency has been selected to change (block 234).

If the PMC 116 determines that the frequency has not been selected to change (block 234: NO), control continues to block 242. If the PMC 116 determines that the frequency has been selected to change (block 234: YES), the PMC 116 performs memory training based on the selected frequency and/or supply voltage (block 236). At block 238, the PMC 116 determines if the memory training has passed (block 238). If the PMC 116 determines that the memory training has not passed (block 238: NO), the PMC 116 continues operation of the memory 1208 with the previously selected clock frequency and/or supply voltage (block 240). If the PMC 116 determines that the memory training has passed (block 238: YES), the PMC 116 outputs one or more control signals to the PLL 104 and/or supply voltage adjustment circuitry 110 to decrease the clock frequency and/or decrease the voltage for supply voltage for the memory 106 (block 242).

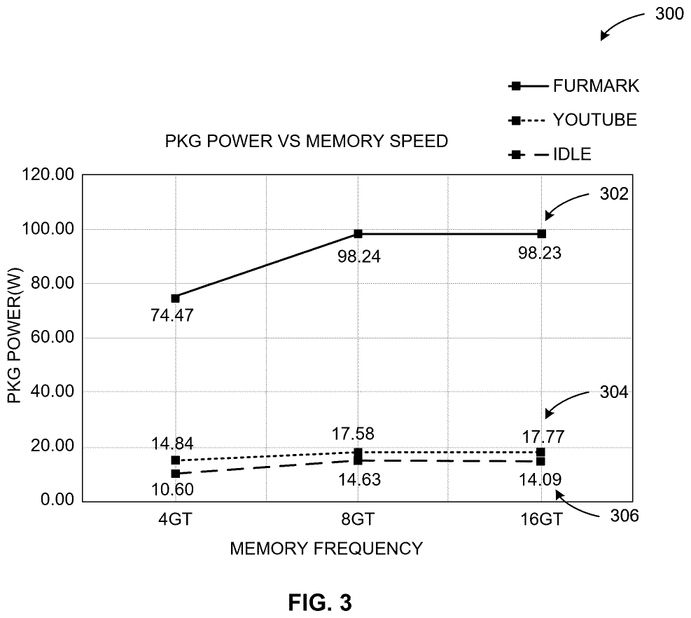

FIG. 3 is an example graph 300 illustrating package (PKG) power in Watts (W) for three example workloads 302, 304, 306 at three different clock frequencies. The first workload 302 corresponds to high workload demands (e.g., software that stresses the processor circuit 112 by increasing power drawn at or above a high workload application). The second workload 304 corresponds to streaming video. The third workload 306 corresponds to an idle workload. As shown in the graph 300, for each of the workloads, the lowest memory frequency results in the least amount of power consumption. Accordingly, for high idle situations (e.g., if display bandwidth is moderate, during idle times of a high workload application, etc.), a lower clock frequency results in significant power savings.

FIG. 4 is a block diagram of an example programmable circuitry platform 400 structured to execute and/or instantiate the example machine-readable instructions and/or the example operations of FIGS. 2A-2C to implement the computing device 100 of FIG. 1. The programmable circuitry platform 400 can be, for example, a server, a personal computer, a workstation, a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, DPUs, EPUs, IPUs and/or microcontrollers from any desired family or manufacturer. The programmable circuitry 412 may be implemented by one or more semiconductor based (e.g., silicon based) devices. In this example, the programmable circuitry 412 implements the DVFS 114 and the PMC 116 of FIG. 1.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), High Bandwidth Memory (HBM), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416. Any one or more of the main memory 414, 416 or the local memory 413 can implement one or more of the memory 106 of FIG. 1.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, a keyboard, a button, a mouse, and/or a touchscreen.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 432, which may be implemented by the machine-readable instructions of FIGS. 2A-2C, may be stored in the mass storage device 428, in the volatile memory 414, in the non-volatile memory 416, and/or on at least one non-transitory computer readable storage medium such as a CD or DVD which may be removable.

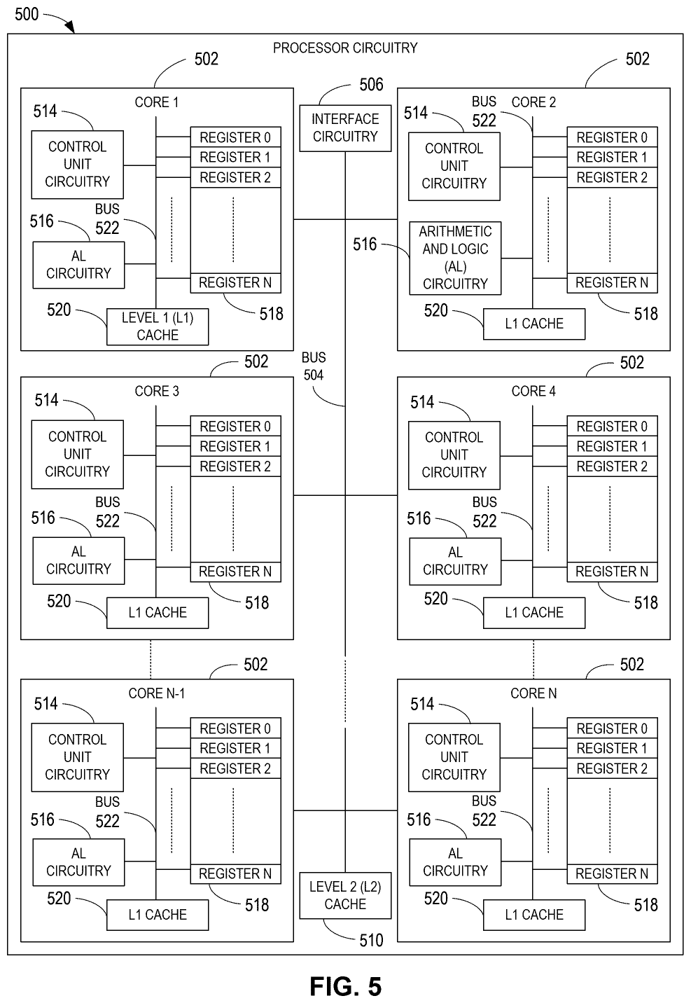

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowcharts of FIGS. 2A-2C to effectively instantiate the circuitry of FIG. 1 as logic circuits to perform operations corresponding to those machine readable instructions. In some such examples, the circuitry of FIG. 1 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIGS. 2A-2C.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

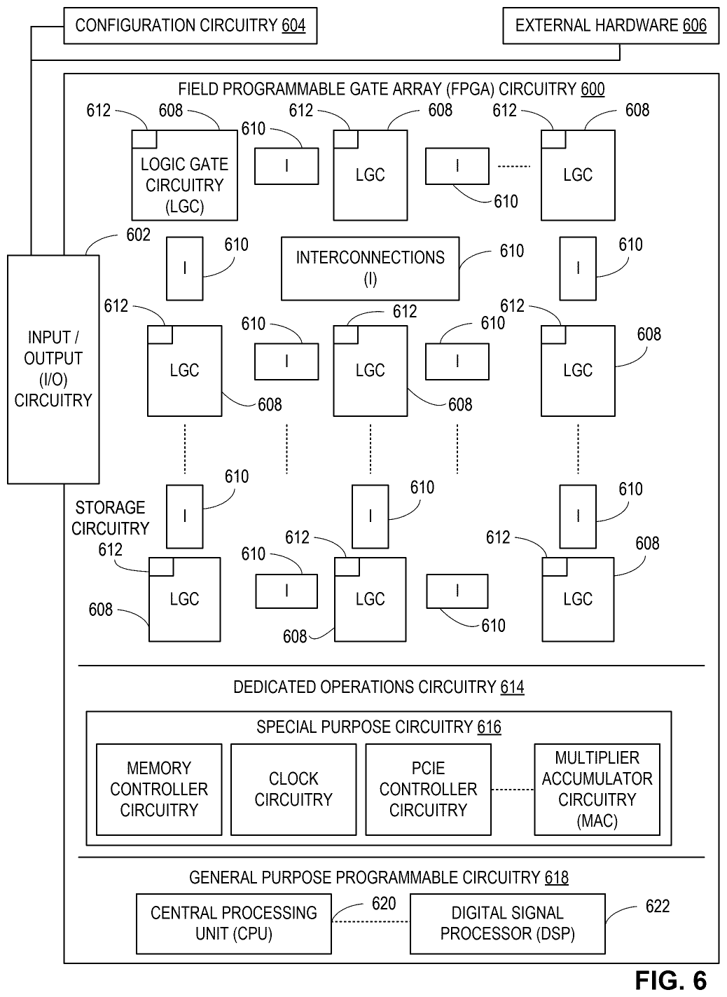

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart(s) of FIGS. 2A-2C but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2A-2C. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2A-2C. As such, the FPGA circuitry 600 may be configured and/or structured to effectively instantiate some or all of the operations/functions corresponding to the machine readable instructions of the flowchart(s) of FIGS. 2A-2C as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIGS. 2A-2C faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIGS. 2A-2C and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, memory reference code (MRC), etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart(s) of FIGS. 2A-2C to perform first operation(s)/function(s), the FPGA circuitry 600 of FIG. 6 may be configured and/or structured to perform second operation(s)/function(s) corresponding to a second portion of the machine readable instructions represented by the flowcharts of FIG. 2A-2C, and/or an ASIC may be configured and/or structured to perform third operation(s)/function(s) corresponding to a third portion of the machine readable instructions represented by the flowcharts of FIGS. 2A-2C.

It should be understood that some or all of the circuitry of FIG. 1 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIG. 1 may be implemented within one or more virtual machines and/or containers executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIG. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

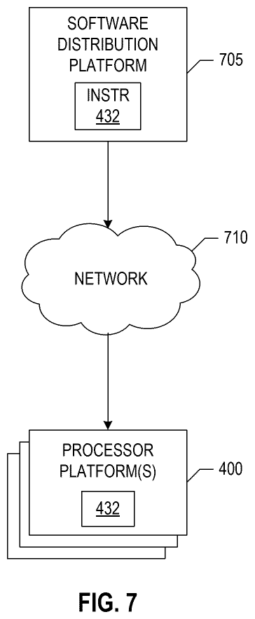

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIGS. 2A-2C, as described above. The one or more servers of the example software distribution platform 705 are in communication with an example network 710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIG. 2A-2C, may be downloaded to the example programmable circuitry platform 400, which is to execute the machine readable instructions 432 to implement the computing device 100 of FIG. 1. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed to reduce memory power consumption. Examples disclosed herein reduce power consumption by dynamically adjusting the clock signal frequency and/or supply voltage delivered to the memory based on, for example, at least two of the actual workload, playback demands, and/or the display bandwidth, rather than adjusting the clock frequency and/or supply voltage solely based on display bandwidth. Examples disclosed herein reduce the voltage supplied to the memory and/or the memory clock frequency to a lower (e.g., minimum supported by the PLL) level during idle periods and scales up the frequency and/or supply voltage based on workload demands. Examples disclosed herein result in power savings during idle, playback, and/or low-load scenarios. Thus, disclosed example systems, apparatus, articles of manufacture, and methods are directed to one or more improvement(s) in the operation of a machine such as a computer or other electronic and/or mechanical device.

Example methods, apparatus, systems, and articles of manufacture to reduce memory power consumption are disclosed herein. Further examples and combinations thereof include the following:

Example 1 includes an apparatus comprising memory, machine-readable instructions, and at least one programmable circuit to at least one of execute or instantiate the machine-readable instructions to at least adjust a frequency of a clock signal to the memory based on a workload demand, and decrease the frequency of the clock signal after the workload demand decreases below a threshold.

Example 2 includes the apparatus of example 1, wherein the threshold is a first threshold, one or more of the at least one programmable circuit is to increase the frequency of the clock signal based on the workload demand being above a second threshold greater than the first threshold.

Example 3 includes the apparatus of example 1, wherein one or more of the at least one programmable circuit is to monitor the workload demand and a bandwidth of the memory.

Example 4 includes the apparatus of example 1, wherein the workload demand is based on user usage of the apparatus.

Example 5 includes the apparatus of example 1, wherein one or more of the at least one programmable circuit is to adjust a supply voltage of the memory based on the workload demand.

Example 6 includes the apparatus of example 1, wherein one or more of the at least one programmable circuit is to adjust the frequency of the clock signal by transmitting a control signal to a phase-locked loop, the phase-locked loop to output the clock signal to the memory.

Example 7 includes a non-transitory computer readable medium comprising instructions that cause at least one programmable circuit to at least monitor a workload demand and a display bandwidth, adjust a frequency of a clock signal to a memory based on the workload demand and the display bandwidth, and decrease the frequency of the clock signal after the workload demand decreases below a threshold.

Example 8 includes the non-transitory computer readable medium of example 7, wherein the threshold is a first threshold, the instructions to cause one or more of the at least one programmable circuit to increase the frequency of the clock signal based on the workload demand being above a second threshold greater than the first threshold.

Example 9 includes the non-transitory computer readable medium of example 7, wherein the workload demand is based on user activity of one or more of the at least one programmable circuit.

Example 10 includes the non-transitory computer readable medium of example 7, wherein the instructions cause one or more of the at least one programmable circuit to adjust a supply voltage of the memory based on the workload demand and the display bandwidth.

Example 11 includes the non-transitory computer readable medium of example 7, wherein the instructions cause one or more of the at least one programmable circuit to adjust the frequency by transmitting a control signal to a phase-locked loop, the phase-locked loop to output the clock signal to the memory.

Example 12 includes an apparatus comprising a phase locked loop (PLL) to provide a clock signal to memory, a driver to monitor a workload demand, and a controller to output a control signal to the PLL to adjust a frequency of the clock signal to the memory based on the workload demand.

Example 13 includes the apparatus of example 12, wherein the controller is to output the control signal to the PLL to decrease the frequency of the clock signal after the workload demand decreases below a threshold.

Example 14 includes the apparatus of example 12, wherein the threshold is a first threshold, wherein the controller is to output the control signal to the PLL to increase the frequency of the clock signal based on the workload demand being above a second threshold greater than the first threshold.

Example 15 includes the apparatus of example 12, wherein the driver is to monitor the workload demand and a bandwidth of the memory.

Example 16 includes the apparatus of example 12, wherein the workload demand is based on user usage of the apparatus.

Example 17 includes the apparatus of example 12, further including a supply voltage adjustment circuitry to adjust a supply voltage provided to the memory, wherein the controller is to output a second control signal to adjust the supply voltage of the memory based on the workload demand.

Example 18 includes the apparatus of example 12, wherein the controller is to perform memory training based on the frequency of the clock signal prior to implementing.

Example 19 includes a method comprising monitoring a workload demand, adjusting a frequency of a clock signal to a memory based on the workload demand, and decreasing the frequency of the clock signal after the workload demand decreases below a threshold.

Example 20 includes the method of example 20, wherein the threshold is a first threshold, including increasing the frequency of the clock signal based on the workload demand being above a second threshold greater than the first threshold.

Example 21 includes the method of example 20, including monitoring the workload demand and a display bandwidth of the memory.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
memory;
machine-readable instructions; and
at least one programmable circuit to at least one of execute or instantiate the machine-readable instructions to at least:
adjust a frequency of a clock signal to the memory based on a workload demand; and
decrease the frequency of the clock signal after the workload demand decreases below a threshold.

2. The apparatus of claim 1, wherein the threshold is a first threshold, one or more of the at least one programmable circuit is to increase the frequency of the clock signal based on the workload demand being above a second threshold greater than the first threshold.

3. The apparatus of claim 1, wherein one or more of the at least one programmable circuit is to monitor the workload demand and a bandwidth of the memory.

4. The apparatus of claim 1, wherein the workload demand is based on user usage of the apparatus.

5. The apparatus of claim 1, wherein one or more of the at least one programmable circuit is to adjust a supply voltage of the memory based on the workload demand.

6. The apparatus of claim 1, wherein one or more of the at least one programmable circuit is to adjust the frequency of the clock signal by transmitting a control signal to a phase-locked loop, the phase-locked loop to output the clock signal to the memory.

7. A non-transitory computer readable medium comprising instructions that cause at least one programmable circuit to at least:
monitor a workload demand and a display bandwidth;
adjust a frequency of a clock signal to a memory based on the workload demand and the display bandwidth; and
decrease the frequency of the clock signal after the workload demand decreases below a threshold.

8. The non-transitory computer readable medium of claim 7, wherein the threshold is a first threshold, the instructions to cause one or more of the at least one programmable circuit to increase the frequency of the clock signal based on the workload demand being above a second threshold greater than the first threshold.

9. The non-transitory computer readable medium of claim 7, wherein the workload demand is based on user activity of one or more of the at least one programmable circuit.

10. The non-transitory computer readable medium of claim 7, wherein the instructions cause one or more of the at least one programmable circuit to adjust a supply voltage of the memory based on the workload demand and the display bandwidth.

11. The non-transitory computer readable medium of claim 7, wherein the instructions cause one or more of the at least one programmable circuit to adjust the frequency by transmitting a control signal to a phase-locked loop, the phase-locked loop to output the clock signal to the memory.

12. An apparatus comprising:
a phase locked loop (PLL) to provide a clock signal to memory;
a driver to monitor a workload demand; and
a controller to:
output a control signal to the PLL to adjust a frequency of the clock signal to the memory based on the workload demand; and
decrease the frequency of the clock signal after the workload demand decreases below a threshold.

13. The apparatus of claim 12, wherein the threshold is a first threshold, wherein the controller is to output the control signal to the PLL to increase the frequency of the clock signal based on the workload demand being above a second threshold greater than the first threshold.

14. The apparatus of claim 12, wherein the driver is to monitor the workload demand and a bandwidth of the memory.

15. The apparatus of claim 12, wherein the workload demand is based on user usage of the apparatus.

16. The apparatus of claim 12, further including a supply voltage adjustment circuitry to adjust a supply voltage provided to the memory, wherein the controller is to output a second control signal to adjust the supply voltage of the memory based on the workload demand.

17. The apparatus of claim 12, wherein the controller is to perform memory training based on the frequency of the clock signal prior to implementing.
